(19) United States
(12) Patent Application Publication
(10) Pub. No.: US 2026/0229573 A1
(43) Pub. Date: Aug. 6, 2026

(54) BUSBAR ASSEMBLY FOR FUEL CELL POWER CONTROL SENSING MODULE INTERFACE

(71) Applicant: GM Global Technology Operations LLC, Detroit, MI (US)

(72) Inventors: Ronald Miller, Rochester, MI (US); Abhishek Kumar Sahu, Bengaluru (IN); Amit Kumar, Rochester Hills, MI (US); Bhaskara K. Ch, Bengaluru (IN); Praveen Kumar Singh, Bengaluru (IN); Peter Karonis, Troy, MI (US)

(21) Appl. No.: 19/043,836

(22) Filed: Feb. 3, 2025

(51) Int. Cl. H01M 8/2465; H01M 8/04007

(52) U.S. Cl. CPC H01M 8/2465; H01M 8/04007; H01M 2250/20

(57) ABSTRACT

A busbar assembly for a fuel cell stack and a fuel cell system is provided. The busbar assembly includes a positive busbar, a negative busbar, and an insulation layer. The positive busbar is formed from aluminum and includes a fuel cell terminal positive end, a module positive end, and a positive heat sink tab disposed between the fuel cell terminal positive end and the module positive end. The positive heat sink tab is offset from the positive electric current path. The negative busbar is formed from aluminum and includes a fuel cell terminal negative end, a module negative end, and a negative heat sink tab disposed between the fuel cell terminal negative end and the module negative end. The negative heat sink tab is offset from the negative electric current path.

### INTRODUCTION

The present invention relates to a fuel cell system, and more particularly to a busbar assembly for use at an interface between a fuel cell stack and a power control sensing module.

Fuel cell systems include a fuel cell stack that produces electrical energy. The fuel cell stack, which includes multiple fuel cells coupled in series, generates electrical power through electrochemical reactions between a hydrogen-based feed gas (e.g., pure hydrogen or a hydrogen reformate) and an oxidant feed gas (e.g., pure oxygen, oxygen-containing air). The power converter and sensing module (PCSM) is a critical component that manages the distribution and regulation of the electrical power generated by the fuel cell stack.

Thus, while present lithium battery cell chemistries achieve their intended purpose, there is a need for new and improved chemistries that offer improved electrochemical performance and cycle life while maintaining ultrafast chargeable capacity.

### SUMMARY

According to several aspects of the present disclosure, a busbar assembly for a fuel cell stack is provided. The busbar assembly includes a positive busbar configured to carry a positive electrical current, a negative busbar configured to carry a negative electrical current, and an insulation layer disposed between the positive busbar and the negative busbar. The positive busbar is formed from at least one of aluminum or an aluminum alloy and includes a fuel cell terminal positive end, a module positive end distal from the fuel cell terminal positive end, and a positive heat sink tab disposed between the fuel cell terminal positive end and the module positive end. A positive electric current path is defined between the fuel cell terminal positive end and the module positive end. The positive heat sink tab is offset from the positive electric current path. The negative busbar is formed from at least one of aluminum or an aluminum alloy and includes a fuel cell terminal negative end, a module negative end distal from the fuel cell terminal negative end, and a negative heat sink tab disposed between the fuel cell terminal negative end and the module negative end. A negative electric current path is defined between the fuel cell terminal negative end and the module negative end. The negative heat sink tab is offset from the negative electric current path, and the negative heat sink tab aligns with the positive heat sink tab.

In accordance with another aspect of the disclosure, the busbar assembly is configured to carry an electric current of 800 amps.

In accordance with another aspect of the disclosure, the busbar assembly is configured to transfer less than five watts of heat to a power converter and sensing module (PCSM).

In accordance with another aspect of the disclosure, the positive busbar and the negative busbar are formed from Electrical Conductor grade aluminum (EC aluminum).

In accordance with another aspect of the disclosure, the positive busbar and the negative busbar include a coating of at least one of tin (Sn), nickel (Ni), silver (Ag), or a silver alloy.

In accordance with another aspect of the disclosure, the positive busbar includes a positive stepped portion disposed between the fuel cell terminal positive end and the module positive end and is disposed proximate to the module positive end. The positive stepped portion is configured to dissipate heat.

In accordance with another aspect of the disclosure, the positive busbar includes a plurality of positive cylindrical cutouts that at least partially define the positive heat sink tab and are configured to direct the electrical current away from the positive heat sink tab.

In accordance with another aspect of the disclosure, the negative busbar includes a negative stepped portion disposed between the fuel cell terminal negative end and the module negative end and is disposed proximate to the module negative end. The negative stepped portion is configured to dissipate heat.

In accordance with another aspect of the disclosure, the negative busbar includes a plurality of negative cylindrical cutouts that at least partially define the negative heat sink tab and are configured to direct the electrical current away from the negative heat sink tab. The negative cylindrical cutouts align with positive cylindrical cutouts.

In accordance with another aspect of the disclosure, the insulating layer includes at least one of an elastomer, a polymer, polytetrafluoroethylene (PTFE), an enamel, a resin coating, or a polyimide tape.

In accordance with another aspect of the disclosure, the insulating layer includes at least one of an insulating insert or a spacer for selective insulation.

According to several aspects of the present disclosure, a vehicle having a fuel cell system is provided. The vehicle having a fuel cell system includes a fuel cell stack having a housing, a power converter and sensing module (PCSM) positioned offset to and rotated about the fuel cell stack, and a busbar assembly disposed at an interface between the fuel cell stack and the power converter and sensing module (PCSM). The busbar assembly includes a positive busbar configured to carry a positive electrical current, a negative busbar configured to carry a negative electrical current, and an insulation layer disposed between the positive busbar and the negative busbar. The positive busbar is formed from at least one of aluminum or an aluminum alloy and includes a fuel cell terminal positive end, a module positive end distal from the fuel cell terminal positive end, a positive heat sink tab disposed between the fuel cell terminal positive end and the module positive end, and a plurality of positive cylindrical cutouts that at least partially define the positive heat sink tab and are configured to direct the electrical current away from the positive heat sink tab. A positive electric current path is defined between the fuel cell terminal positive end and the module positive end, and the positive heat sink tab is offset from the positive electric current path. The negative busbar is formed from at least one of aluminum or an aluminum alloy and includes a fuel cell terminal negative end, a module negative end distal from the fuel cell terminal negative end, a negative heat sink tab disposed between the fuel cell terminal negative end and the module negative end, and a plurality of negative cylindrical cutouts that at least partially define the negative heat sink tab and are configured to direct the electrical current away from the negative heat sink tab. A negative electric current path is defined between the fuel cell terminal negative end and the module negative end. The negative heat sink tab is offset from the negative electric current path, and the negative heat sink tab aligns with the positive heat sink tab. The negative cylindrical cutouts align with the positive cylindrical cutouts.

In accordance with another aspect of the disclosure, the busbar assembly is configured to carry an electric current of 800 amps.

In accordance with another aspect of the disclosure, the positive busbar and the negative busbar are formed from Electrical Conductor grade aluminum (EC aluminum).

In accordance with another aspect of the disclosure, the positive busbar and the negative busbar include a coating of at least one of tin (Sn), nickel (Ni), silver (Ag), or a silver alloy.

In accordance with another aspect of the disclosure, the positive busbar includes a positive stepped portion disposed between the fuel cell terminal positive end and the module positive end and is disposed proximate to the module positive end. The positive stepped portion is configured to dissipate heat.

In accordance with another aspect of the disclosure, the negative busbar includes a negative stepped portion disposed between the fuel cell terminal negative end and the module negative end and is disposed proximate to the module negative end. The negative stepped portion is configured to dissipate heat.

In accordance with another aspect of the disclosure, the insulating layer includes at least one of an elastomer, a polymer, polytetrafluoroethylene (PTFE), an enamel, a resin coating, or a polyimide tape.

In accordance with another aspect of the disclosure, the insulating layer includes at least one of an insulating insert or a spacer for selective insulation.

According to several aspects of the present disclosure, a busbar assembly for a fuel cell stack is provided. The busbar assembly includes a positive busbar configured to carry a positive electrical current, a negative busbar configured to carry a negative electrical current, and an insulating layer disposed between the positive busbar and the negative busbar. The positive busbar is formed from at least one of aluminum or an aluminum alloy and includes a fuel cell terminal positive end, a module positive end distal from the fuel cell terminal positive end, a positive heat sink tab disposed between the fuel cell terminal positive end and the module positive end, a plurality of positive cylindrical cutouts that at least partially define the positive heat sink tab and are configured to direct the electrical current away from the positive heat sink tab, and a positive stepped portion disposed between the fuel cell terminal positive end and the module positive end and proximate to the module positive end. A positive electric current path is defined between the fuel cell terminal positive end and the module positive end. The positive heat sink tab is offset from the positive electric current path. The negative busbar is formed from at least one of aluminum or an aluminum alloy and includes a fuel cell terminal negative end, a module negative end distal from the fuel cell terminal negative end, a negative heat sink tab disposed between the fuel cell terminal negative end and the module negative end, a plurality of negative cylindrical cutouts that at least partially define the negative heat sink tab and are configured to direct the electrical current away from the negative heat sink tab, and a negative stepped portion disposed between the fuel cell terminal negative end and the module negative end and proximate to the module negative end. A negative electric current path is defined between the fuel cell terminal negative end and the module negative end. The negative heat sink tab is offset from the negative electric current path and aligns with the positive heat sink tab. The negative cylindrical cutouts align with the positive cylindrical cutouts.

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings.

FIG. 1 is a perspective view illustrating an example of a vehicle having an electric motor powered by a fuel cell stack having a busbar assembly, in accordance with the present disclosure.

FIG. 2 is an isometric view of a fuel cell stack and a power control sensing module in the vehicle shown in FIG. 1, in accordance with the present disclosure.

FIG. 3 is a top plan view of the busbar assembly in the fuel cell stack shown in FIG. 2, in accordance with the present disclosure.

FIG. 4 is an isometric view of the busbar assembly shown in FIG. 3, in accordance with the present disclosure.

FIG. 5 is a top plan view of a positive busbar in the busbar assembly shown in FIGS. 3 and 4, in accordance with the present disclosure.

FIG. 6 is a top plan view of a negative busbar in the busbar assembly shown in FIGS. 3 and 4, in accordance with the present disclosure.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. The following description is merely exemplary in nature and is not intended to limit the present disclosure, application, or uses.

Busbars are conductive bars used to distribute electrical power within the fuel cell stack and between the stack and the power converter and sensing module (PCSM). Traditional busbar assemblies, however, may face limitations in their ability to dissipate heat effectively, especially when positioned between the fuel cell stack and the PCSM without active cooling. Small amounts of heat generated due to ohmic losses increase temperatures significantly near the busbars. Heat entering the PCSM is also critical and may have an effect on a functionality of sensing, monitoring, and measuring devices inside the PCSM. This may result in hotspots, thermal stress, and uneven temperature distribution, which may adversely affect the performance and durability of the fuel cell system.

The busbar assembly disclosed herein addresses these issues by providing a busbar assembly configured for enhanced heat dissipation. The busbar assembly optimizes thermal management and heat dissipation ensuring that heat generated within the fuel cell stack is efficiently transferred away from critical components. By integrating structural modifications, the proposed busbar assembly enhances the overall thermal performance of the fuel cell system, contributing to increased efficiency, reliability, and safety.

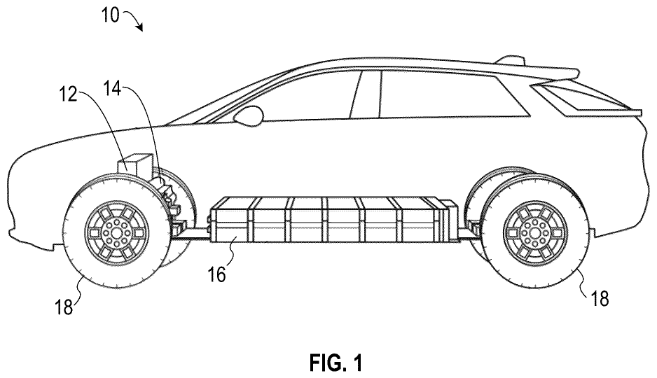

Referring to FIG. 1, a perspective view of a vehicle 10 having a fuel cell stack 12, a power converter and sensing module (PCSM) 14, and a vehicle battery pack 16 is illustrated, in accordance with the present disclosure. The fuel cell stack 12, the PCSM 14, and a battery pack 16 is illustrated with an exemplary vehicle 10. The vehicle 10 may be an electric vehicle or hybrid vehicle having wheels 18 driven by at least one electric motor/inverter (not shown). The electric motors/inverters receive power from the battery pack 16, which receives electricity from the fuel cell stack 12. While the vehicle 10 is illustrated as a passenger road vehicle, it should be appreciated that the fuel cell stack 12 and the battery pack 16 may be used with various other types of vehicles. For example, the fuel cell stack 12 and the battery pack 16 may be used in nautical vehicles, such as boats, or aeronautical vehicles, such as drones or passenger airplanes. The vehicle 10 may include a fuel cell-based hybrid/electric vehicle, for example a truck, an off-highway vehicle, or a vehicle configured to convey people or transport goods. Moreover, the fuel cell stack 12 and the battery pack 16 may be used as a stationary power source separate and independent from a vehicle.

As used herein, the term “vehicle” is not limited to automobiles. While the present technology is described primarily herein in connection with electric and hybrid-electric vehicles, the technology is not limited to electric and hybrid-electric vehicles. The concepts can be used in a wide variety of applications, such as in connection with components used in motorcycles, mopeds, locomotives, aircraft, marine craft, and other vehicles, as well as in other applications utilizing batteries, such as in portable power stations, such as those used for powering remote job sites, emergency back-up power supplies, and permanent power stations associated with buildings and equipment, all of which may be powered by, for example, solar or wind-powered generator systems, power mains, and fuel based power generators such as gasoline, propane, kerosene, or diesel generators as well as sterling engines.

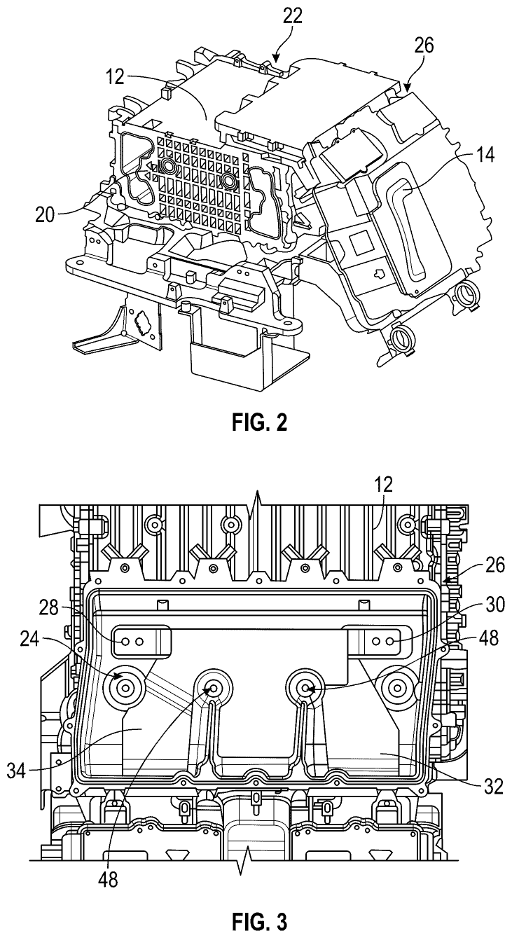

FIG. 2 illustrates the fuel cell stack 12 illustrated in FIG. 1. The fuel cell stack 12 produces electrical power. The fuel cell stack 12 has a housing 20 and includes multiple individual fuel cells arranged in series, where each cell contains an anode (not shown), a cathode (not shown), and a proton exchange membrane (PEM) or polymer electrolyte membrane (PEM) (not shown) between the anode and the cathode. Hydrogen is fed into the anode side, where the hydrogen splits into protons and electrons. The protons pass through the membrane to the cathode, while the electrons travel through an external circuit, creating an electric current. At the cathode, the protons, electrons, and oxygen from air combine to form water and release heat.

FIG. 2 illustrates the PCSM 14 coupled to the fuel cell stack 12. The PCSM 14 monitors and controls various components of a fuel cell system and fuel cell stack 12 including a hydrogen gas injector, an electric air compressor, a recirculation pump, and sensors, none of which are shown. The PCSM 14 ensures that the fuel cell stack 12 provides a required amount of electrical power based on demand. The PCSM may include a power electronic device which senses fuel cell voltages, measures currents, and/or works as a converter. As shown in FIG. 2, the PCSM 14 may be coupled with the fuel cell stack 12 in an offset and rotated configuration (e.g., the PCSM 14 is not coupled to the fuel cell stack 12 on a first side 22 or the top end). The PCSM 14 may be offset and rotated about the fuel cell stack 12 to minimize height of the combination fuel cell stack 12 and PCSM 14.

Referring to FIG. 3, a busbar assembly 24 is illustrated at an interface 26 between the fuel cell stack 12 and the PCSM 14. The busbar assembly 24 serves as a high-current conductor and efficiently transmits electrical power generated by the fuel cell stack 12 to the PCSM 14 via a positive terminal 28 and a negative terminal 30 of the fuel cell stack 12. The busbar assembly 24 electrically couples the positive terminal 28 and negative terminal 30 of the fuel cell stack 12 to corresponding terminals on the PCSM 14. In an example, the busbar assembly 24 is configured to carry an electric current of about 800 amps (A). In this context, the term “about” will be understood by one of skill in the art. Alternatively, the term “about” means plus or minus 5 amps (A). In another example, the busbar assembly 24 is configured to transfer less than five watts (W) of heat to the PCSM 14. In this context, the term “about” will be understood by one of skill in the art. Alternatively, the term “about” means plus or minus 0.5 W. It will be appreciated that the busbar assembly 24 may include other configurations and may be configured to carry or transfer other amounts of electric current. The busbar assembly 24 may be located in a housing of the fuel cell stack 12 and is away from an active cooling mechanism. Thus, a small amount of heat generated due to ohmic losses increases temperature significantly proximate to the busbar assembly 24.

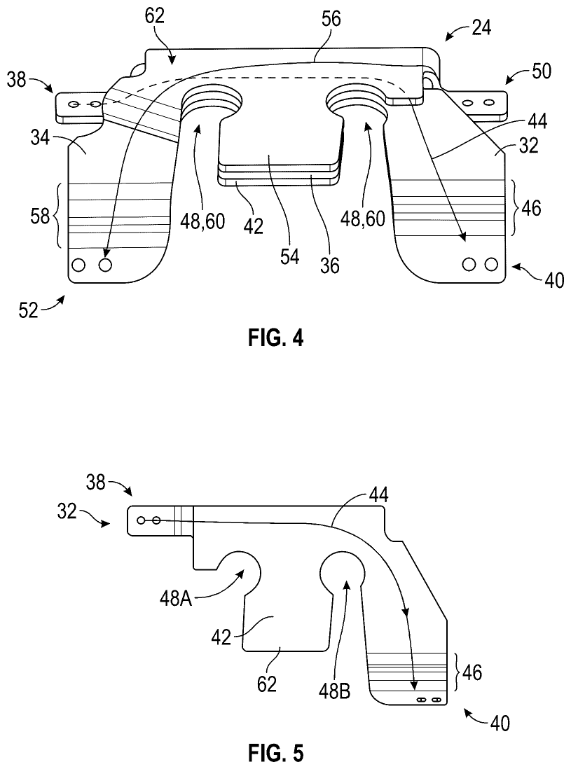

As illustrated in FIGS. 3 and 4, the busbar assembly 24 includes a positive busbar 32, a negative busbar 34, and an insulation layer 36. As illustrated, the positive busbar 32 is configured to overlay the negative busbar 34 with the insulation layer 36 disposed between the positive busbar 32 and the negative busbar 34. However, it will be appreciated that the positive busbar 32 and the negative busbar 34 may not necessarily overlay each other and may include other configurations.

The positive busbar 32 includes a fuel cell terminal positive end 38, a module positive end 40, and a positive heat sink tab 42. The positive busbar 32 may be formed from aluminum or an aluminum alloy, and preferably Electrical Conductor grade aluminum (EC aluminum). The fuel cell terminal positive end 38 may be configured to transfer a positive electrical current from the fuel cell stack 12 and is electrically coupled to the positive terminal 28 of the fuel cell stack 12. The module positive end 40 is configured to transfer the positive electrical current to the PCSM 14 and is electrically coupled to the PCSM 14. A positive current path 44 is defined between the fuel cell terminal positive end 38 and the module positive end 40 through which positive electrical current generally flows.

FIGS. 3-5 illustrate the positive heat sink tab 42. The positive heat sink tab 42 extends from a portion of the positive busbar 32 including the positive current path 44. The positive heat sink tab 42 may be configured as a tab, a flap, an extension, an appendage, and/or a portion of the positive busbar 32 that extends away from or is located away from the positive current path 44. In the example illustrated in FIG. 5, the positive heat sink tab 42 is configured as a tab. The positive heat sink tab 42 is configured to dissipate heat from the positive busbar 32 and the busbar assembly 24.

In the example shown in FIGS. 4 and 5, the positive busbar 32 includes a positive stepped portion 46. The positive stepped portion 46 includes a series of steps, ribs, corrugations, furrows, and/or striations, which are configured at least for dissipating heat from the positive busbar 32 and the busbar assembly 24. The positive stepped portion 46 is shown located at a location of the positive busbar 32 within a portion of the positive current path 44, although the positive stepped portion 46 may be disposed at other locations of the positive busbar 32.

Referring to FIGS. 3-5, the positive busbar 32 includes at least one positive cylindrical cutout 48. Each positive cylindrical cutout 48 may include a partial cutout of a portion of the positive busbar 32 near or proximate to the positive heat sink tab 42. In the example illustrated in FIG. 5, two positive cylindrical cutouts 48A, 48B are shown on distal sides of the positive heat sink tab 42. These positive cylindrical cutouts 48A, 48B may be configured to passively direct positive electric current along the positive current path 44 and away from the positive heat sink tab 42. Each positive cylindrical cutout 48 functions to prevent or minimize heat creation within the positive heat sink tab 42. It will be appreciated that each positive cylindrical cutout 48 may include other locations or configurations than those shown in FIGS. 3-5.

Referring to FIGS. 3-4 and 6, the negative busbar 34 includes a fuel cell terminal negative end 50, a module negative end 52, and a negative heat sink tab 54. In the examples shown in FIGS. 3-4 and 6, the negative busbar 34 may be configured as a mirror representation of the positive busbar 32, although the negative busbar 34 may include other configurations. The negative busbar 34 may be formed from aluminum or an aluminum alloy, and preferably Electrical Conductor grade (EC) aluminum. The fuel cell terminal negative end 50 is configured to transfer a negative electrical current from the fuel cell stack 12 and is electrically coupled to the negative terminal 30 of the fuel cell stack 12. The module negative end 52 is configured to transfer the negative electrical current to the PCSM 14 and is electrically coupled to the PCSM 14. A negative current path 56 is defined between the fuel cell terminal negative end 50 and the module negative end 52 through which negative electrical current flows.

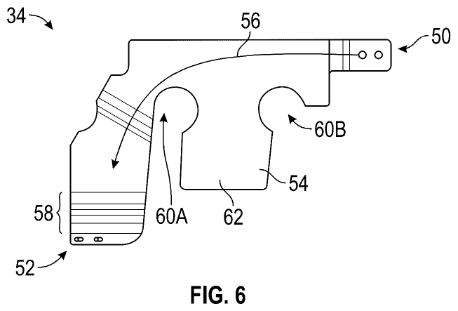

FIGS. 3-4 and 6 illustrate the negative heat sink tab 54. The negative heat sink tab 54 extends from a portion of the negative busbar 34 including the negative current path 56. The negative heat sink tab 54 may be configured as a tab, a flap, an extension, an appendage, and/or a portion of the negative busbar 34 that extends away from or is located away from the negative current path 56. In the example illustrated in FIG. 6, the negative heat sink tab 54 is configured as a tab. The negative heat sink tab 54 is configured to dissipate heat from the negative busbar 34 and the busbar assembly 24.

In the example shown in FIGS. 4 and 6, the negative busbar 34 includes a negative stepped portion 58. The negative stepped portion 58 includes a series of steps, ribs, corrugations, furrows, and/or striations, which are configured at least for dissipating heat from the negative busbar 34 and the busbar assembly 24. The negative stepped portion 58 is shown located at a portion of the negative busbar 34 within a portion of the negative current path 56, although the negative stepped portion 58 may be disposed at other locations of the negative busbar 34.

Referring to FIGS. 3-4 and 6, the negative busbar 34 includes at least one negative cylindrical cutout 60. Each negative cylindrical cutout 60 may include a partial cutout of a portion of the negative busbar 34 near or proximate to the negative heat sink tab 54. In the example illustrated in FIG. 6, two negative cylindrical cutouts 60A, 60B are shown on distal sides of the negative heat sink tab 54. These negative cylindrical cutouts 60A, 60B may be configured to passively direct negative electric current along the negative current path 56 and away from the negative heat sink tab 54. Each negative cylindrical cutout 60 functions to prevent or minimize heat creation within the negative heat sink tab 54. It will be appreciated that each negative cylindrical cutout 60 may include other locations or configurations than those shown in FIGS. 3-4 and 6.

The positive busbar 32 and/or the negative busbar 34 may include a coating 62. The coating 62 can function to enhance corrosion resistance, prevent or eliminate oxidation, and improve contact surfaces. Some examples of the coating 62 may include tin (Sn), nickel (Ni), silver (Ag), and/or a silver alloy. It will be appreciated that the coating 62 may include other materials, compositions, or formulations suitable to coat the positive busbar 32 and/or the negative busbar 34.

Referring to FIG. 4, the busbar assembly 24 includes an insulation layer 36 disposed between the positive busbar 32 and the negative busbar 34. The insulation layer 36 is configured to prevent electrical current from escaping each respective busbar and contacting other conductive materials. The insulation layer 36 may be disposed over all or a portion of an area between the positive busbar 32 and the negative busbar 34 or may be in the form of inserts or spacers between the positive busbar 32 and the negative busbar 34 for selective insulation. In some examples, the insulation layer 36 may be formed from an elastomer, a polymer, polytetrafluoroethylene (PTFE), an enamel, a resin coating, and/or a polyimide tape.

In one specific example, the positive busbar 32 is configured to carry a positive electrical current of about 800 amps (A) and heat less than 5 watts (W). In this example, the positive heat sink tab 42 has about a 100 millimeters (mm) width, about a 60 mm length, and about a 10 mm thickness. In this context, the term “about” will be understood by one of skill in the art. Alternatively, the term “about” is defined as plus or minus 10 mm for the width and length and plus or minus 2 mm for the thickness. The negative busbar 34 and the negative heat sink tab 54 may include similar dimensions. It will be understood that the positive busbar 32, the positive heat sink tab 42, the negative busbar 34, and the negative heat sink tab 54 may include other configurations.

The busbar assembly 24 of the present disclosure is advantageous and beneficial over the prior art. By using aluminum, the busbar assembly 24 benefits from a weight reduction and a cost reduction and an insignificant change in voltage drop and ohmic losses when compared to conventional copper busbars. By reducing voltage drop and ohmic losses, heat generation within the busbar assembly 24 is controlled. Aluminum is less thermally conductive than copper and hence limits ohmic heat from flowing toward the PCSM. Additionally, the busbar assembly 24 benefits from improved cooling performance due to the positive heat sink tab 42 and the negative heat sink tab 54 being offset from the electric current flow path and due to effectively dissipating any heat that is generated. Further, the busbar assembly 24 is designed to direct the electrical currents away from the positive heat sink tab 42 and the negative heat sink tab 54, which further reduces heat generation and supports heat dissipation.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A busbar assembly for a fuel cell stack, comprising:
a positive busbar configured to carry a positive electrical current, the positive busbar formed from at least one of aluminum or an aluminum alloy and including
a fuel cell terminal positive end;
a module positive end distal from the fuel cell terminal positive end, wherein
a positive electric current path is defined between the fuel cell terminal positive end and the module positive end; and
a positive heat sink tab disposed between the fuel cell terminal positive end and the module positive end, wherein the positive heat sink tab is offset from the positive electric current path;
a negative busbar configured to carry a negative electrical current, the negative busbar formed from at least one of aluminum or an aluminum alloy and including
a fuel cell terminal negative end;
a module negative end distal from the fuel cell terminal negative end, wherein a negative electric current path is defined between the fuel cell terminal negative end and the module negative end; and
a negative heat sink tab disposed between the fuel cell terminal negative end and the module negative end, wherein the negative heat sink tab is offset from the negative electric current path, wherein the negative heat sink tab aligns with the positive heat sink tab; and
an insulation layer disposed between the positive busbar and the negative busbar.

2. The busbar assembly of claim 1, wherein the busbar assembly is configured to carry an electric current of 800 amps.

3. The busbar assembly of claim 1, wherein the busbar assembly is configured to transfer less than five watts of heat to a power converter and sensing module (PCSM).

4. The busbar assembly of claim 1, wherein the positive busbar and the negative busbar are formed from Electrical Conductor grade aluminum (EC aluminum).

5. The busbar assembly of claim 1, wherein the positive busbar and the negative busbar include a coating of at least one of tin (Sn), nickel (Ni), silver (Ag), or a silver alloy.

6. The busbar assembly of claim 1, wherein the positive busbar includes a positive stepped portion disposed between the fuel cell terminal positive end and the module positive end and disposed proximate to the module positive end, and wherein the positive stepped portion is configured to dissipate heat.

7. The busbar assembly of claim 1, wherein the positive busbar includes a plurality of positive cylindrical cutouts that at least partially define the positive heat sink tab and are configured to direct the electrical current away from the positive heat sink tab.

8. The busbar assembly of claim 1, wherein the negative busbar includes a negative stepped portion disposed between the fuel cell terminal negative end and the module negative end and disposed proximate to the module negative end, and wherein the negative stepped portion is configured to dissipate heat.

9. The busbar assembly of claim 1, wherein the negative busbar includes a plurality of negative cylindrical cutouts that at least partially define the negative heat sink tab and are configured to direct the electrical current away from the negative heat sink tab, wherein the negative cylindrical cutouts align with positive cylindrical cutouts.

10. The busbar assembly of claim 1, wherein the insulating layer includes at least one of an elastomer, a polymer, polytetrafluoroethylene (PTFE), an enamel, a resin coating, or a polyimide tape.

11. The busbar assembly of claim 1, wherein the insulating layer includes at least one of an insulating insert or a spacer for selective insulation.

12. A vehicle having a fuel cell system, comprising:
a fuel cell stack having a housing;
a power converter and sensing module (PCSM) positioned offset to and rotated about the fuel cell stack; and
a busbar assembly disposed at an interface between the fuel cell stack and the power converter and sensing module (PCSM), wherein the busbar assembly includes
a positive busbar configured to carry a positive electrical current, the positive busbar formed from at least one of aluminum or an aluminum alloy and including
a fuel cell terminal positive end;
a module positive end distal from the fuel cell terminal positive end, wherein a positive electric current path is defined between the fuel cell terminal positive end and the module positive end;
a positive heat sink tab disposed between the fuel cell terminal positive end and the module positive end, wherein the positive heat sink tab is offset from the positive electric current path; and
a plurality of positive cylindrical cutouts that at least partially define the positive heat sink tab and are configured to direct the electrical current away from the positive heat sink tab;
a negative busbar configured to carry a negative electrical current, the negative busbar formed from at least one of aluminum or an aluminum alloy and including
a fuel cell terminal negative end;
a module negative end distal from the fuel cell terminal negative end, wherein a negative electric current path is defined between the fuel cell terminal negative end and the module negative end;
a negative heat sink tab disposed between the fuel cell terminal negative end and the module negative end, wherein the negative heat sink tab is offset from the negative electric current path, wherein the negative heat sink tab aligns with the positive heat sink tab; and
a plurality of negative cylindrical cutouts that at least partially define the negative heat sink tab and are configured to direct the electrical current away from the negative heat sink tab, wherein the negative cylindrical cutouts align with the positive cylindrical cutouts; and
an insulation layer disposed between the positive busbar and the negative busbar.

13. The fuel cell system of claim 12, wherein the busbar assembly is configured to carry an electric current of 800 amps.

14. The fuel cell system of claim 12, wherein the positive busbar and the negative busbar are formed from Electrical Conductor grade aluminum (EC aluminum).

15. The fuel cell system of claim 12, wherein the positive busbar and the negative busbar include a coating of at least one of tin (Sn), nickel (Ni), silver (Ag), or a silver alloy.

16. The fuel cell system of claim 12, wherein the positive busbar includes a positive stepped portion disposed between the fuel cell terminal positive end and the module positive end and disposed proximate to the module positive end, and wherein the positive stepped portion is configured to dissipate heat.

17. The fuel cell system of claim 12, wherein the negative busbar includes a negative stepped portion disposed between the fuel cell terminal negative end and the module negative end and disposed proximate to the module negative end, and wherein the negative stepped portion is configured to dissipate heat.

18. The fuel cell system of claim 12, wherein the insulating layer includes at least one of an elastomer, a polymer, polytetrafluoroethylene (PTFE), an enamel, a resin coating, or a polyimide tape.

19. The fuel cell system of claim 12, wherein the insulating layer includes at least one of an insulating insert or a spacer for selective insulation.

20. A busbar assembly for a fuel cell stack, comprising:
a positive busbar configured to carry a positive electrical current, the positive busbar formed from at least one of aluminum or an aluminum alloy and including
a fuel cell terminal positive end;
a module positive end distal from the fuel cell terminal positive end, wherein a positive electric current path is defined between the fuel cell terminal positive end and the module positive end;
a positive heat sink tab disposed between the fuel cell terminal positive end and the module positive end, wherein the positive heat sink tab is offset from the positive electric current path;
a plurality of positive cylindrical cutouts that at least partially define the positive heat sink tab and are configured to direct the electrical current away from the positive heat sink tab; and
a positive stepped portion disposed between the fuel cell terminal positive end and the module positive end and proximate to the module positive end; and
a negative busbar configured to carry a negative electrical current, the negative busbar formed from at least one of aluminum or an aluminum alloy and including
a fuel cell terminal negative end;
a module negative end distal from the fuel cell terminal negative end, wherein a negative electric current path is defined between the fuel cell terminal negative end and the module negative end;
a negative heat sink tab disposed between the fuel cell terminal negative end and the module negative end, wherein the negative heat sink tab is offset from the negative electric current path, wherein the negative heat sink tab aligns with the positive heat sink tab;
a plurality of negative cylindrical cutouts that at least partially define the negative heat sink tab and are configured to direct the electrical current away from the negative heat sink tab, wherein the negative cylindrical cutouts align with the positive cylindrical cutouts; and
a negative stepped portion disposed between the fuel cell terminal negative end and the module negative end and proximate to the module negative end; and
an insulating layer disposed between the positive busbar and the negative busbar.
